(19) United States
(12) Patent Application Publication
(10) Pub. No.: US 2026/0332354 A1
(43) Pub. Date: Oct. 22, 2026

(54) METHODS AND APPARATUSES FOR HARQ-ACK FEEDBACK MULTIPLEXING ON A PUSCH FOR CARRIER AGGREGATION

(71) Applicant: LENOVO (BEIJING) LIMITED, Beijing (CN)

(72) Inventor: Haipeng LEI, Beijing (CN)

(21) Appl. No.: 19/112,135

(22) PCT Filed: Nov. 4, 2022
(86) PCT No.: PCT/CN2022/130020

§ 371 Date: Mar. 14, 2025

(51) Int. Cl. H04L 5/00; H04L 1/1812; H04W 72/232

(52) U.S. Cl. CPC H04L 5/0055; H04L 1/1812; H04W 72/232

(57) ABSTRACT

Embodiments of the present disclosure relate to methods and apparatuses for hybrid automatic repeat request acknowledgement (HARQ-ACK) feedback multiplexing on a physical uplink shared channel (PUSCH) for carrier aggregation (CA). According to some embodiments of the disclosure, a user equipment (UE) may include: a transceiver configured to receive one or more downlink control information (DCI) formats scheduling a plurality of PUSCHs on a plurality of serving cells of the UE; a processor coupled to the transceiver and configured to: determine that one or more PUSCHs of the plurality of PUSCHs overlap a physical uplink control channel (PUCCH) carrying HARQ-ACK feedback for a downlink transmission; and determine a reference PUSCH among the plurality of PUSCHs for multiplexing the HARQ-ACK feedback; and wherein the transceiver is further configured to transmit the plurality of PUSCHs, wherein the HARQ-ACK feedback is multiplexed on the reference PUSCH.

### TECHNICAL FIELD

Embodiments of the present disclosure generally relate to wireless communication technology, and more particularly to hybrid automatic repeat request acknowledgement (HARQ-ACK) feedback multiplexing on a physical uplink shared channel (PUSCH) for carrier aggregation (CA).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a base station (BS) may transmit data signals to a user equipment (UE) via a physical downlink shared channel (PDSCH), or a UE may transmit data signals to a BS via a PUSCH. In order to increase the data rate, CA technology may be used in the wireless communication system. For example, CA technology may refer to aggregating spectrum resources (e.g., carriers) from the same frequency band or different frequency bands for a UE. When CA technology is used, a plurality of PDSCHs may be transmitted on a plurality of carriers, or a plurality of PUSCHs may be transmitted on a plurality of carriers.

The UE may transmit HARQ-ACK feedback for the plurality of PDSCHs. Accordingly, there is a need for handling HARQ-ACK feedback transmission when a plurality of PUSCHs is scheduled in a wireless communication system.

### SUMMARY

Some embodiments of the present disclosure provide a UE. The UE may include: a transceiver configured to receive one or more downlink control information (DCI) formats scheduling a plurality of PUSCHs on a plurality of serving cells of the UE; a processor coupled to the transceiver and configured to: determine that one or more PUSCHs of the plurality of PUSCHs overlap a physical uplink control channel (PUCCH) carrying HARQ-ACK feedback for downlink transmission; and determine a reference PUSCH among the plurality of PUSCHs for multiplexing the HARQ-ACK feedback; and wherein the transceiver is further configured to transmit the plurality of PUSCHs, wherein the HARQ-ACK feedback is multiplexed on the reference PUSCH.

In some embodiments of the present disclosure, the reference PUSCH satisfies the UE's processing delay requirement on multiplexing the HARQ-ACK feedback.

In some embodiments of the present disclosure, a DCI format of the one or more DCI formats includes a beta offset indicator applicable for the reference PUSCH for adjusting resources of the HARQ-ACK feedback on the reference PUSCH.

In some embodiments of the present disclosure, the one or more DCI formats comprise at least one multi-cell scheduling DCI format, each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.

In some embodiments of the present disclosure, the corresponding second set of serving cells is configured with a parameter for determining control channel elements (CCEs) of physical downlink control channel (PDCCH) candidates for monitoring the multi-cell scheduling DCI format.

In some embodiments of the present disclosure, a DCI size of each of the at least one multi-cell scheduling DCI format is counted on a serving cell of the corresponding second set of serving cells.

In some embodiments of the present disclosure, a blind detection (BD) or control channel element (CCE) budget of each of the at least one multi-cell scheduling DCI format is counted on a serving cell of the corresponding second set of serving cells.

In some embodiments of the present disclosure, a search space of each of the at least one multi-cell scheduling DCI format is configured on a serving cell of the corresponding second set of serving cells.

In some embodiments of the present disclosure, the serving cell of the corresponding second set of serving cells is configured by radio resource control (RRC) signaling.

In some embodiments of the present disclosure, to determine the reference PUSCH, the processor is configured to perform at least one of the following: determining the reference PUSCH to be a PUSCH on a primary cell (PCell) or a primary secondary cell (PSCell) of the plurality of serving cells; determining the reference PUSCH to be a PUSCH which ends latest among the plurality of PUSCHs; determining the reference PUSCH to be a PUSCH which starts earliest among the plurality of PUSCHs; determining the reference PUSCH to be a PUSCH which starts latest among the plurality of PUSCHs; determining the reference PUSCH to be a PUSCH with the smallest serving cell index among the plurality of serving cells; determining the reference PUSCH to be a PUSCH with the largest serving cell index among the plurality of serving cells; determining the reference PUSCH to be a PUSCH on a serving cell with a predefined order among a combination of serving cells indicated by a DCI format among the one or more DCI formats; determining the reference PUSCH to be a PUSCH with the most time-frequency resources among the plurality of PUSCHs; determining the reference PUSCH to be a PUSCH with the smallest serving cell index among at least one PUSCH of the plurality of PUSCHs with the same ending time; determining the reference PUSCH to be a PUSCH with the largest serving cell index among at least one PUSCH of the plurality of PUSCHs with the same ending time; determining the reference PUSCH to be a PUSCH with the smallest serving cell index among at least one PUSCH of the plurality of PUSCHs with the same starting time; or determining the reference PUSCH to be a PUSCH with the largest serving cell index among at least one PUSCH of the plurality of PUSCHs with the same starting time.

In some embodiments of the present disclosure, to determine the reference PUSCH, the processor is configured to perform at least one of the following: in the case that only one PUSCH of the plurality of PUSCHs overlaps the PUCCH, determining the reference PUSCH to be the one PUSCH; determining the reference PUSCH to be a PUSCH which ends latest among the one or more PUSCHs; determining the reference PUSCH to be a PUSCH which starts earliest among the one or more PUSCHs; determining the reference PUSCH to be a PUSCH which starts latest among the one or more PUSCHs; determining the reference PUSCH to be a PUSCH with the smallest serving cell index among the one or more PUSCHs; determining the reference PUSCH to be a PUSCH with the largest serving cell index among the one or more PUSCHs; determining the reference PUSCH to be a PUSCH with the most time-frequency resources among the one or more PUSCHs; determining the reference PUSCH to be a PUSCH with the smallest serving cell index among at least one PUSCH of the one or more PUSCHs with the same ending time; determining the reference PUSCH to be a PUSCH with the largest serving cell index among at least one PUSCH of the one or more PUSCHs with the same ending time; determining the reference PUSCH to be a PUSCH with the smallest serving cell index among at least one PUSCH of the one or more PUSCHs with the same starting time; or determining the reference PUSCH to be a PUSCH with the largest serving cell index among at least one PUSCH of the one or more PUSCHs with the same starting time.

Some embodiments of the present disclosure provide a BS. The BS may include: a transceiver configured to transmit, to a UE, one or more DCI formats scheduling a plurality of PUSCHs on a plurality of serving cells of the UE; a processor coupled to the transceiver and configured to: determine that one or more PUSCHs of the plurality of PUSCHs overlap a PUCCH carrying HARQ-ACK feedback for downlink transmission; and determine a reference PUSCH among the plurality of PUSCHs for multiplexing the HARQ-ACK feedback; and wherein the transceiver is further configured to receive the plurality of PUSCHs, wherein the HARQ-ACK feedback is multiplexed on the reference PUSCH.

In some embodiments of the present disclosure, the reference PUSCH satisfies the UE's processing delay requirement on multiplexing the HARQ-ACK feedback.

In some embodiments of the present disclosure, a DCI format of the one or more DCI formats includes a beta offset indicator applicable for the reference PUSCH for adjusting resources of the HARQ-ACK feedback on the reference PUSCH.

In some embodiments of the present disclosure, the one or more DCI formats comprise at least one multi-cell scheduling DCI format, each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.

In some embodiments of the present disclosure, the corresponding second set of serving cells is configured with a parameter for determining control channel elements (CCEs) of physical downlink control channel (PDCCH) candidates for monitoring the multi-cell scheduling DCI format.

In some embodiments of the present disclosure, a DCI size of each of the at least one multi-cell scheduling DCI format is counted on a serving cell of the corresponding second set of serving cells.

In some embodiments of the present disclosure, a BD or CCE budget of each of the at least one multi-cell scheduling DCI format is counted on a serving cell of the corresponding second set of serving cells.

In some embodiments of the present disclosure, a search space of each of the at least one multi-cell scheduling DCI format is configured on a serving cell of the corresponding second set of serving cells.

In some embodiments of the present disclosure, the transceiver is further configured to transmit radio resource control (RRC) signaling to the UE to indicate the serving cell of the corresponding second set of serving cells to the UE.

In some embodiments of the present disclosure, to determine the reference PUSCH, the processor is configured to perform at least one of the following: determining the reference PUSCH to be a PUSCH on a PCell or a PSCell of the plurality of serving cells; determining the reference PUSCH to be a PUSCH which ends latest among the plurality of PUSCHs; determining the reference PUSCH to be a PUSCH which starts earliest among the plurality of PUSCHs; determining the reference PUSCH to be a PUSCH which starts latest among the plurality of PUSCHs; determining the reference PUSCH to be a PUSCH with the smallest serving cell index among the plurality of serving cells; determining the reference PUSCH to be a PUSCH with the largest serving cell index among the plurality of serving cells; determining the reference PUSCH to be a PUSCH on a serving cell with a predefined order among a combination of serving cells indicated by a DCI format among the one or more DCI formats; determining the reference PUSCH to be a PUSCH with the most time-frequency resources among the plurality of PUSCHs; determining the reference PUSCH to be a PUSCH with the smallest serving cell index among at least one PUSCH of the plurality of PUSCHs with the same ending time; determining the reference PUSCH to be a PUSCH with the largest serving cell index among at least one PUSCH of the plurality of PUSCHs with the same ending time; determining the reference PUSCH to be a PUSCH with the smallest serving cell index among at least one PUSCH of the plurality of PUSCHs with the same starting time; or determining the reference PUSCH to be a PUSCH with the largest serving cell index among at least one PUSCH of the plurality of PUSCHs with the same starting time.

In some embodiments of the present disclosure, to determine the reference PUSCH, the processor is configured to perform at least one of the following: in the case that only one PUSCH of the plurality of PUSCHs overlaps the PUCCH, determining the reference PUSCH to be the one PUSCH; determining the reference PUSCH to be a PUSCH which ends latest among the one or more PUSCHs; determining the reference PUSCH to be a PUSCH which starts earliest among the one or more PUSCHs; determining the reference PUSCH to be a PUSCH which starts latest among the one or more PUSCHs; determining the reference PUSCH to be a PUSCH with the smallest serving cell index among the one or more PUSCHs; determining the reference PUSCH to be a PUSCH with the largest serving cell index among the one or more PUSCHs; determining the reference PUSCH to be a PUSCH with the most time-frequency resources among the one or more PUSCHs; determining the reference PUSCH to be a PUSCH with the smallest serving cell index among at least one PUSCH of the one or more PUSCHs with the same ending time; determining the reference PUSCH to be a PUSCH with the largest serving cell index among at least one PUSCH of the one or more PUSCHs with the same ending time; determining the reference PUSCH to be a PUSCH with the smallest serving cell index among at least one PUSCH of the one or more PUSCHs with the same starting time; or determining the reference PUSCH to be a PUSCH with a predefined serving cell index among at least one PUSCH of the one or more PUSCHs with the same starting time.

Some embodiments of the present disclosure provide a method performed by a UE. The method may include: receiving one or more DCI formats scheduling a plurality of PUSCHs on a plurality of serving cells of the UE; determining that one or more PUSCHs of the plurality of PUSCHs overlap a PUCCH carrying HARQ-ACK feedback for downlink transmission; determining a reference PUSCH among the plurality of PUSCHs for multiplexing the HARQ-ACK feedback; and transmitting the plurality of PUSCHs, wherein the HARQ-ACK feedback is multiplexed on the reference PUSCH.

Some embodiments of the present disclosure provide a method performed by a BS. The method may include: transmitting, to a UE, one or more DCI formats scheduling a plurality of PUSCHs on a plurality of serving cells of the UE; determining that one or more PUSCHs of the plurality of PUSCHs overlap a PUCCH carrying HARQ-ACK feedback for downlink transmission; determining a reference PUSCH among the plurality of PUSCHs for multiplexing the HARQ-ACK feedback; and receiving the plurality of PUSCHs, wherein the HARQ-ACK feedback is multiplexed on the reference PUSCH.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate schematic diagrams of a DCI format scheduling multiple PUSCHs in accordance with some embodiments of the present disclosure;

FIG. 4 illustrates a schematic diagram of multiple DCI formats scheduling multiple PUSCHs in accordance with some embodiments of the present disclosure;

FIG. 5 is a flow chart illustrating an exemplary method for HARQ-ACK feedback multiplexing on a PUSCH according to some embodiments of the present disclosure; and

FIG. 6 illustrates a simplified block diagram of an exemplary apparatus for HARQ-ACK feedback multiplexing on a PUSCH according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

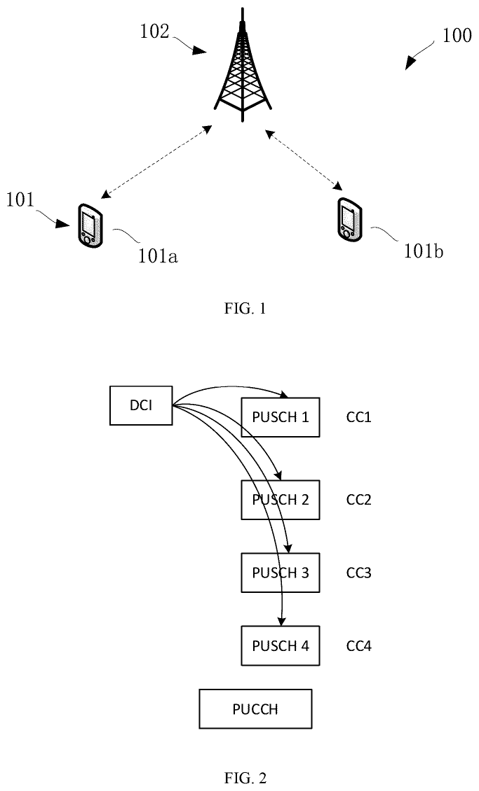

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

NR supports a wide range of spectrums in different frequency ranges. In the market for 5G Advanced, it is expected that the availability of the spectrum will be increased, which is possibly due to re-farming the bands originally used for previous cellular generation networks. For example, for some low frequency bands of FR1 (e.g., 450 MHz-6000 MHz), the available spectrum bands tend to be more fragmented and scattered with a narrower bandwidth. In addition, for bands of FR2 (24250 MHz-52600 MHz) and some bands of FR1 (frequency range 1), the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth becomes available, it is advisable to allow simultaneous scheduling of multiple cells.

NR is designed to support a max of 16 component carriers (CCs) in the case of CA or a max of 32 CCs in the case of dual connectively (DC). In some embodiments of the present disclosure, in the case of CA, one DCI can schedule at most one carrier by cross-carrier scheduling or self-scheduling. This requires much signaling overhead for PDCCHs to schedule PDSCHs when the number of carriers configured for a UE is large. To reduce signaling overhead, it is beneficial to use a single DCI to schedule multiple PDSCHs or PUSCHs on multiple carriers configured to the UE.

In some cases, a PUCCH carrying HARQ-ACK feedback for downlink transmission (e.g., one or more PDSCHs) may overlap one or more PUSCHs of multiple PUSCHs co-scheduled by a single DCI. In such cases, how to multiplex the HARQ-ACK feedback on the multiple PUSCHs co-scheduled by the single DCI needs to be solved. If this technical problem is not solved, the HARQ-ACK codebook may be mismatched between a UE and a BS, e.g., the HARQ-ACK codebook generated by UE may not match what the BS expects.

FIG. 2 illustrates a schematic diagram of a DCI format scheduling multiple PUSCHs in accordance with some embodiments of the present disclosure.

Referring to FIG. 2, a DCI format (also referred to as a DCI) may schedule (e.g., co-schedule) four PUSCHs on four different serving cells (or four different component carriers (CCs)). In some embodiments of the present disclosure, a serving cell may be represented by a CC. For example, in FIG. 2, the DCI may schedule PUSCH 1 on CC1, PUSCH 2 on CC2, PUSCH 3 on CC3, and PUSCH 4 on CC4. In some embodiments, the DCI may be transmitted on one cell of CC1 to CC4. In some other embodiments, the DCI may be transmitted on a cell other than CC1 to CC4.

In the example of FIG. 2, HARQ-ACK feedback for a PDSCH(s) is to be transmitted in a PUCCH which overlaps the 4 co-scheduled PUSCHs in a time domain. In such example, the HARQ-ACK feedback may be multiplexed on one PUSCH of the 4 co-scheduled PUSCHs. Then, which PUSCH of the 4 co-scheduled PUSCHs may be used to multiplex the HARQ-ACK feedback needs to be resolved.

Given the above, embodiments of the present disclosure propose solutions for HARQ-ACK feedback multiplexing on a PUSCH for CA, which can at least solve the above technical problems. For example, embodiments of the present disclosure provide several solutions for determining a reference PUSCH to multiplex the HARQ-ACK feedback when multiple PUSCHs are scheduled by one or more DCI formats. More details on the embodiments of the present disclosure will be illustrated in the following text in combination with the appended drawings.

### Embodiment 1

In Embodiment 1, a BS (e.g., BS 102 as shown in FIG. 1) may configure a set of serving cells for multi-cell scheduling via a multi-cell scheduling DCI format (named as DCI format 0_X for uplink scheduling or DCI format 1_X for downlink scheduling for simplicity) for a UE (e.g., UE 101 as shown in FIG. 1).

For example, the set of serving cells may include up to 4 cells, 8 cells, or other number of cells. The set of serving cells may be associated with a table configured by RRC signaling or a predefined table. Each row of the table may define a co-scheduled cell combination (e.g., a set of co-scheduled cells within the set of serving cells). In some embodiments, a maximum of 4 cells within the set of serving cells may be defined in each co-scheduled cell combination, i.e., a maximum of 4 cells within the set of serving cells may be scheduled by a multi-cell scheduling DCI format.

In Embodiment 1, the BS may transmit a multi-cell scheduling DCI format scheduling a plurality of PUSCHs on a plurality of serving cells to the UE. Each PUSCH in the plurality of PUSCHs may be scheduled on a corresponding serving cell of the plurality of serving cells. The plurality of serving cells may be a subset of the set of serving cells as stated above. For example, the multi-cell scheduling DCI format may include an indicator indicating a row of the table associated with the set of cells, and the row may define a set of co-scheduled cells. The plurality of serving cells may include one or more cells in the set of co-scheduled cells, which may be a subset of the set of serving cells configured for multi-cell scheduling using DCI format 0_X or DCI format 1_X, which will be illustrated below in detail.

In some embodiments, the multi-cell scheduling DCI format may include a UL downlink assignment index (DAI). The DAI may indicate the number of {serving cell, PDCCH monitoring occasion}-pair(s) in which PDSCH transmission(s) associated with PDCCH or PDCCH indicating semi-persistent scheduling (SPS) PDSCH release or DCI format 1_1 indicating secondary cell (SCell) dormancy is present.

In some embodiments, the multi-cell scheduling DCI format may include a beta offset indicator.

In some cases, the UE or the BS may determine that one or more PUSCHs of the plurality of PUSCHs overlap a PUCCH carrying HARQ-ACK feedback for a downlink transmission (e.g., one or more PDSCHs). In such cases, the UE and the BS may determine a reference PUSCH among the plurality of PUSCHs for multiplexing the HARQ-ACK feedback. The UE may not transmit the PUCCH and thus the BS may not receive the PUCCH. The beta offset indicator included in the multi-cell scheduling DCI format may be applicable for the reference PUSCH for adjusting resources of the HARQ-ACK feedback on the reference PUSCH.

In some embodiments, the reference PUSCH for multiplexing the HARQ-ACK feedback may satisfy a condition(s).

For example, the reference PUSCH may be a PUSCH actually transmitted (e.g., denoted as condition (1)). Whether a PUSCH is actually transmitted may be determined as follows: for the one or more co-scheduled cells indicated by the multi-cell scheduling DCI format, if, for a cell from the one or more co-scheduled cells, at least one symbol from a set of symbols where the UE is scheduled PUSCH transmission in the cell is a downlink symbol (e.g., as indicated by a cell common UL/DL configuration such as tdd-UL-DL-ConfigurationCommon as specified in 3GPP standard documents or a UE specific UL/DL configuration such as tdd-UL-DL-ConfigurationDedicated as specified in 3GPP standard documents), the UE does not transmit the PUSCH in the cell.

For example, considering the UE's processing delay on multiplexing HARQ-ACK feedback on a PUSCH, the reference PUSCH for multiplexing the HARQ-ACK feedback may satisfy the UE's processing delay requirement (e.g., denoted as condition (2)).

The plurality of PUSCHs based on which the reference PUSCH is determined may satisfy at least one of condition (1) or condition (2), and the plurality of serving cells are the serving cells in the set of co-scheduled cells indicated by the multi-cell scheduling DCI format on which the plurality of PUSCHs are transmitted.

The following embodiments may provide several solutions for determining the reference PUSCH from the plurality of PUSCHs.

### Solution #1

In solution #1, when the plurality of serving cells include a PCell or PSCell, the BS or the UE may determine the reference PUSCH to be a PUSCH on the PCell or the PSCell of the plurality of serving cells. In such embodiments, the HARQ-ACK feedback may be transmitted on a PCell or a PSCell with high reliability.

### Solution #2

In solution #2, the BS or the UE may determine the reference PUSCH to be a PUSCH which ends latest among the plurality of PUSCHs. In such embodiments, the UE may have sufficient time to multiplex HARQ-ACK feedback on the reference PUSCH.

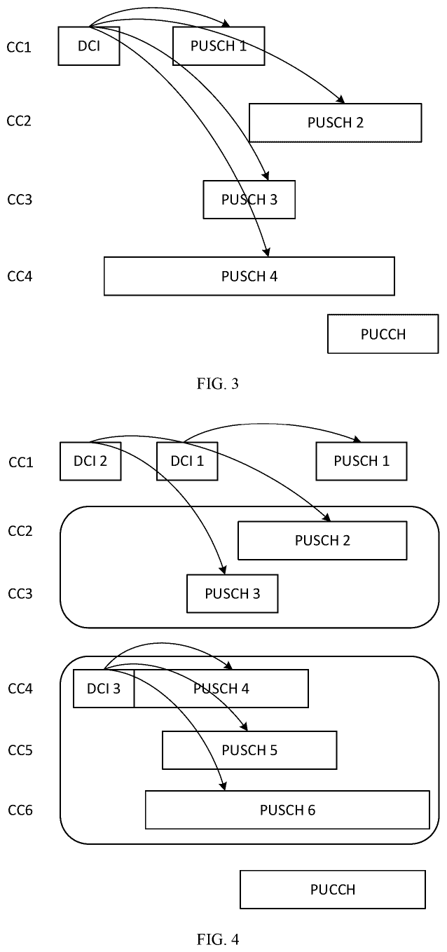

FIG. 3 illustrates a schematic diagram of a DCI format scheduling multiple PUSCHs in accordance with some embodiments of the present disclosure.

Referring to FIG. 3, a multi-cell scheduling DCI may schedule four PUSCHs on four different serving cells. For example, the multi-cell scheduling DCI may schedule PUSCH 1 on CC1, PUSCH 2 on CC2, PUSCH 3 on CC3, and PUSCH 4 on CC4. It is assumed that the ascending order of the serving cell indices of CC1 to CC4 is CC1->CC2->CC3->CC4. In the example of FIG. 3, the DCI is transmitted on CC1. In some other examples, the DCI can be transmitted on a CC different from CC1 to CC4. As shown in FIG. 3, HARQ-ACK feedback for a PDSCH(s) is to be transmitted in a PUCCH which overlaps PUSCH 2 and PUSCH 4 in the time domain.

In solution #2, the BS or the UE may determine PUSCH 2 to be the reference PUSCH because PUSCH 2 ends latest among the 4 PUSCHs.

### Solution #3

In solution #3, the BS or the UE may determine the reference PUSCH to be a PUSCH which starts earliest among the plurality of PUSCHs. In such embodiments, the UE may transmit the HARQ-ACK feedback at the earliest time. Referring to FIG. 3, in solution #3, the BS and the UE may determine PUSCH 4 to be the reference PUSCH because PUSCH 4 starts earliest among the 4 PUSCHs.

### Solution #4

In solution #4, the BS or the UE may determine the reference PUSCH to be a PUSCH which starts latest among the plurality of PUSCHs. In such embodiments, the UE may have sufficient time to multiplex HARQ-ACK feedback on the reference PUSCH. Referring to FIG. 3, in solution #4, the BS and the UE may determine PUSCH 2 to be the reference PUSCH because PUSCH 2 starts latest among the 4 PUSCHs.

### Solution #5

In solution #5, the BS or the UE may determine the reference PUSCH to be a PUSCH with a pre-defined serving cell index among the plurality of serving cells. In some embodiments, solution #5 may be used in combination with other solutions for determining a reference PUSCH, for example, one of solutions #2-4. For instance, when there are two or more PUSCHs with the same starting time or ending time, solution #5 may be further employed.

In some embodiments of solution #5, the pre-defined serving cell index may be the smallest serving cell index among the plurality of serving cells. In such embodiments, referring to FIG. 3, the BS and the UE may determine PUSCH 1 to be the reference PUSCH because PUSCH 1 is transmitted on CC1 which has the smallest serving cell index.

In some embodiments of solution #5, the pre-defined serving cell index may be the largest serving cell index among the plurality of serving cells. In such embodiments, referring to FIG. 3, the BS and the UE may determine PUSCH 4 to be the reference PUSCH because PUSCH 4 is transmitted on CC4 which has the largest serving cell index.

### Solution #6

In solution #6, the BS or the UE may determine the reference PUSCH to be a PUSCH on a serving cell with a predefined order among a combination of serving cells indicated by the multi-cell scheduling DCI format. For example, it is assumed that: the multi-cell scheduling DCI format indicates a row of the table as stated above, wherein the row defines four co-scheduled serving cells to be CC4, CC2, CC3, and CC1 as shown in FIG. 3; and the PUSCHs on CC4, CC2, and CC3 satisfy conditions (1) and (2) as stated above. Accordingly, the plurality of serving cells (e.g., a combination of serving cells) indicated by the multi-cell scheduling DCI format are CC4, CC2, and CC3 indicated by the multi-cell scheduling DCI format.

In some embodiments of solution #6, the pre-defined order may refer to the first serving cell among a combination of serving cells. In such embodiments, referring to FIG. 3, the BS and the UE may determine PUSCH 4 to be the reference PUSCH because PUSCH 4 is transmitted on CC4 which is the first serving cell among a combination of CC4, CC2, and CC3.

In some embodiments of solution #6, the pre-defined order may refer to the last serving cell among a combination of serving cells. In such embodiments, referring to FIG. 3, the BS and the UE may determine PUSCH 3 to be the reference PUSCH because PUSCH 3 is transmitted on CC3 which is the last serving cell among a combination of CC4, CC2, and CC3.

### Solution #7

In solution #7, the BS or the UE may determine the reference PUSCH to be a PUSCH with the most time-frequency resources among the plurality of PUSCHs. In such embodiments, the impact on the PUSCH due to multiplexing the HARQ-ACK feedback may be minimal. Referring to FIG. 3, in solution #7, the BS and the UE may determine PUSCH 4 to be the reference PUSCH because PUSCH 4 has the most time-frequency resources among the 4 PUSCHs.

### Solution #8

In solution #8, the BS or the UE may determine the reference PUSCH to be a PUSCH with a pre-defined serving cell index among at least one PUSCH of the plurality of PUSCHs. The at least one PUSCH of the plurality of PUSCHs may have the same ending time.

In some embodiments of solution #8, the pre-defined serving cell index may be the smallest serving cell index among at least one serving cells on which the at least one PUSCH is transmitted.

In some embodiments of solution #8, the pre-defined serving cell index may be the largest serving cell index among at least one serving cells on which the at least one PUSCH is transmitted.

### Solution #9

In solution #9, the BS or the UE may determine the reference PUSCH to be a PUSCH with a pre-defined serving cell index among at least one PUSCH of the plurality of PUSCHs. The at least one PUSCH of the plurality of PUSCHs may have the same starting time.

In some embodiments of solution #9, the pre-defined serving cell index may be the smallest serving cell index among at least one serving cells on which the at least one PUSCH is transmitted.

In some embodiments of solution #9, the pre-defined serving cell index may be the largest serving cell index among at least one serving cells on which the at least one PUSCH is transmitted.

### Solution #10

In solution #10, only one PUSCH of the plurality of PUSCHs may overlap the PUCCH. Then, the BS and the UE may determine the reference PUSCH to be the one PUSCH.

### Solution #11

In solution #11, the BS or the UE may determine the reference PUSCH to be a PUSCH on a serving cell with a pre-defined serving cell index among the serving cells carrying one or more PUSCHs overlapping the PUCCH.

In some embodiments of solution #11, the pre-defined serving cell index may be the smallest serving cell index. In such embodiments, referring to FIG. 3, since PUSCH 2 and PUSCH 4 overlap the PUCCH, the UE and the BS may determine PUSCH 2 to be the reference PUSCH because PUSCH 2 is transmitted on CC2 which has the smallest serving cell index among CC2 and CC4.

In some embodiments of solution #11, the pre-defined serving cell index may be the largest serving cell index. In such embodiments, referring to FIG. 3, since PUSCH 2 and PUSCH 4 overlap the PUCCH, the UE and the BS may determine PUSCH 4 to be the reference PUSCH because PUSCH 4 is transmitted on CC4 which has the largest serving cell index among CC2 and CC4.

### Solution #12

In solution #12, the BS or the UE may determine the reference PUSCH to be a PUSCH which ends latest among the one or more PUSCHs overlapping the PUCCH. In solution #12, referring to FIG. 3, since PUSCH 2 and PUSCH 4 overlap the PUCCH, the UE and the BS may determine PUSCH 2 to be the reference PUSCH because PUSCH 2 ends latest among PUSCH 2 and PUSCH 4.

### Solution #13

In solution #13, the BS or the UE may determine the reference PUSCH to be a PUSCH which starts earliest among the one or more PUSCHs overlapping the PUCCH. In solution #13, referring to FIG. 3, since PUSCH 2 and PUSCH 4 overlap the PUCCH, the UE and the BS may determine PUSCH 4 to be the reference PUSCH because PUSCH 4 starts earliest among PUSCH 2 and PUSCH 4.

### Solution #14

In solution #14, the BS or the UE may determine the reference PUSCH to be a PUSCH which starts latest among the one or more PUSCHs overlapping the PUCCH. In solution #14, referring to FIG. 3, since PUSCH 2 and PUSCH 4 overlap the PUCCH, the UE and the BS may determine PUSCH 2 to be the reference PUSCH because PUSCH 2 starts latest among PUSCH 2 and PUSCH 4.

### Solution #15

In solution #15, the BS or the UE may determine the reference PUSCH to be a PUSCH with the most time-frequency resources among the one or more PUSCHs overlapping the PUCCH. In solution #15, referring to FIG. 3, since PUSCH 2 and PUSCH 4 overlap the PUCCH, the UE and the BS may determine PUSCH 4 to be the reference PUSCH because PUSCH 4 has more time-frequency resources than PUSCH 2.

### Solution #16

In solution #16, the BS or the UE may determine the reference PUSCH to be a PUSCH on a serving cell with a pre-defined serving cell index among the serving cell(s) carrying at least one PUSCH of the one or more PUSCHs overlapping the PUCCH. The at least one PUSCH of the plurality of PUSCHs may have the same ending time.

In some embodiments of solution #16, the pre-defined serving cell index may be the smallest serving cell index among the serving cell(s) on which the at least one PUSCH is transmitted.

In some embodiments of solution #16, the pre-defined serving cell index may be the largest serving cell index among the serving cell(s) on which the at least one PUSCH is transmitted.

### Solution #17

In solution #17, the BS or the UE may determine the reference PUSCH to be a PUSCH on a serving cell with a pre-defined serving cell index among the serving cell(s) carrying at least one PUSCH of the one or more PUSCHs overlapping the PUCCH. The at least one PUSCH of the plurality of PUSCHs may have the same starting time.

In some embodiments of solution #17, the pre-defined serving cell index may be the smallest serving cell index among the serving cell(s) on which the at least one PUSCH is transmitted.

In some embodiments of solution #17, the pre-defined serving cell index may be the largest serving cell index among the serving cell(s_ on which the at least one PUSCH is transmitted.

The BS and the UE may use at least one of the above solutions to determine the reference PUSCH from the plurality of PUSCHs. Then, the UE may transmit the plurality of PUSCHs, wherein the HARQ-ACK feedback is multiplexed on the reference PUSCH. Consequently, the BS may receive the plurality of PUSCHs, wherein the HARQ-ACK feedback is multiplexed on the reference PUSCH.

### Embodiment 2

In Embodiment 2, a BS (e.g., BS 102 as shown in FIG. 1) may configure one or more sets of serving cells for multi-cell scheduling via one or more multi-cell scheduling DCI formats (named as DCI format 0_X for UL scheduling or DCI format 1_X for DL scheduling for simplicity) for a UE (e.g., UE 101 as shown in FIG. 1), wherein a multi-cell scheduling DCI format may schedule one or more serving cells within a set of serving cells of the one or more sets of serving cells. The intersection of the one or more sets of serving cells is null, i.e., a serving cell can only be included in one set of serving cells, or a serving cell included in one set of serving cells cannot be included in another set of serving cells.

For example, each set of serving cells of the one or more sets of serving cells may include up to 4 cells, 8 cells, or other number of cells. Each set of serving cells may be associated with a corresponding table configured by RRC signaling or a predefined table. Each row of the corresponding table may define a co-scheduled cell combination (e.g., a set of co-scheduled cells within the corresponding set of serving cells). In some embodiments, a maximum of 4 cells within the corresponding set of serving cells may be defined in each co-scheduled cell combination, i.e., a maximum of 4 cells within a set of serving cells may be scheduled by a multi-cell scheduling DCI format.

In some embodiments, each set of serving cells may be associated with a search space configuration for monitoring a corresponding multi-cell scheduling DCI format. The search space of a multi-cell scheduling DCI format scheduling a cell combination within a corresponding set of serving cells may be configured on a (single) serving cell of the corresponding set of serving cells. In some embodiments, the serving cell on which the search space is configured may be configured by RRC signaling or predefined. For example, the serving cell on which the search space is configured may be the serving cell with the smallest serving cell index within the corresponding set of serving cells, or the serving cell with the largest serving cell index within the corresponding set of serving cells.

In some embodiments, each set of serving cells may correspond to a DCI size for a corresponding multi-cell scheduling DCI format. The DCI size of a multi-cell scheduling DCI format scheduling a cell combination within a corresponding set of serving cells may be counted on a (single) serving cell of the corresponding set of serving cells (e.g., for DCI size alignment). In some embodiments, the serving cell on which the DCI size is counted may be configured by RRC signaling or predefined. In some examples, the serving cell on which the DCI size of the multi-cell scheduling DCI format is counted on may be the serving cell on which the search space of the multi-cell scheduling DCI format is configured. In some other examples, the serving cell on which the DCI size is counted may be the serving cell with the smallest serving cell index within the corresponding set of serving cells, or the serving cell with the largest serving cell index within the corresponding set of serving cells.

In some embodiments, for each set of serving cells, a BD or CCE budget of a multi-cell scheduling DCI format scheduling a cell combination within a corresponding set of serving cells may be counted on a (single) serving cell of the corresponding set of serving cells. In some embodiments, the serving cell on which the BD or CCE budget is counted may be configured by RRC signaling or predefined. In some examples, the serving cell on which the BD or CCE budget of the multi-cell scheduling DCI format is counted on may be the serving cell on which the search space of the multi-cell scheduling DCI format is configured. In some other examples, the serving cell on which the BD or CCE budget of the multi-cell scheduling DCI format is counted may be the serving cell with the smallest serving cell index within the corresponding set of serving cells, or the serving cell with the largest serving cell index within the corresponding set of serving cells.

In an embodiment, a serving cell on which a DCI size of a multi-cell scheduling DCI format is counted may be the same or different as a serving cell on which a BD or CCE budget of the multi-cell scheduling DCI format is counted. In an embodiment, a serving cell on which a DCI size of a multi-cell scheduling DCI format is counted and a serving cell on which a BD or CCE budget of the multi-cell scheduling DCI format is counted may be separately configured or may be configured using the same signaling.

In some embodiments, each set of serving cells may be configured with a parameter (e.g., denoted as n_{CI}) for determining CCEs of PDCCH candidates for monitoring a corresponding multi-cell scheduling DCI format. In an embodiment, different sets of serving cells may be configured with different values of the parameter. Due to different values of the parameter per set of serving cells, the UE may differentiate the scheduled set of serving cells when monitoring CCEs of PDCCH candidates.

For example, the following equation may be used for determining CCEs of PDCCH candidates for monitoring a multi-cell scheduling DCI format:
for a search space set s associated with control resource set (CORESET) p, the CCE indexes for aggregation level L corresponding to PDCCH candidate m_{s,n}_{_{CI}} of the search space set in slot

$${n}_{s , f}^{μ}$$

for an active downlink (DL) bandwidth part (BWP) of a serving cell corresponding to n_{CI} are given by

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , m ax}^{( L )}} ⌋ + {n}_{CI} ) mod ⌊ {N}_{CCE , p} / L ⌋ \} + i .$$

Where:
for any common search space (CSS),

$${Y}_{p , {n}_{s , f}^{μ}} = 0 ;$$

for a UE specific search space (USS),

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNT1}≠0, Aₚ=39827 for pmod3=0, Aₚ=39829 for pmod3=1, Aₚ=39839 for pmod3=2, and D=65537; i=0, . . . , L−1;
N_{CCE,p} is the number of CCEs, numbered from 0 to N_{CCE,p}−1, in CORESET p and, if any, per resource block (RB) set;
n_{CI} is the parameter as stated above, which is the carrier indicator field value if the UE is configured with a carrier indicator field by CrossCarrierSchedulingConfig for the serving cell on which PDCCH is monitored; otherwise, including for any CSS, n_{CI}=0;
m_{s,n}_{_{CI}}=0, . . . ,

$${M}_{s , {n}_{CI}}^{( L )} - 1 ,$$

where

$${M}_{s , {n}_{CI}}^{( L )}$$

is the number of PDCCH candidates the UE is configured to monitor for aggregation level L of a search space set s for a serving cell corresponding to n_{CI}; for any CSS,

$${M}_{s , m ax}^{( L )} = {M}_{s , 0}^{( L )} ;$$

### for a USS,

$${M}_{s , m ax}^{( L )}$$

is the maximum of

$${M}_{s , {n}_{CI}}^{( L )}$$

over all configured n_{CI} values for a CCE aggregation level L of search space set s; the radio network temporary identity (RNTI) value used for n_{RNTI} is the cell-radio network temporary identifier (C-RNTI).

In Embodiment 2, the BS may transmit one or more DCI formats scheduling a plurality of PUSCHs on a plurality of serving cells. Each PUSCH in the plurality of PUSCHs may be scheduled on a corresponding serving cell of the plurality of serving cells.

In some embodiments, the one or more DCI formats may include at least one multi-cell scheduling DCI format (e.g., DCI format 0_X for UL scheduling or DCI format 1_X for DL scheduling), each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format. The corresponding second set of serving cells may be a set of serving cells within the one or more sets of serving cells configured by the BS as stated above.

For example, each of the at least one multi-cell scheduling DCI format may include an indicator indicating a row of a table associated with the corresponding second set of serving cells, and the row may define a set of co-scheduled cells within the corresponding second set of serving cells. The respective first set of serving cells may be the set of co-scheduled cells or a subset of the set of co-scheduled cells.

In an embodiment, the corresponding second set of serving cells is configured with a parameter (e.g., n_{CI} as stated above) for determining CCEs of PDCCH candidates for monitoring the multi-cell scheduling DCI format.

In an embodiment, a DCI size of each of the at least one multi-cell scheduling DCI format is counted on a serving cell (e.g., a single serving cell) of the corresponding second set of serving cells. For example, the serving cell of the corresponding second set of serving cells may be configured by RRC signaling.

In an embodiment, a BD or CCE budget of each of the at least one multi-cell scheduling DCI format is counted on a serving cell (e.g., a single serving cell) of the corresponding second set of serving cells. For example, the serving cell of the corresponding second set of serving cells may be configured by RRC signaling

In an embodiment, a search space of each of the at least one multi-cell scheduling DCI format is configured on a serving cell (e.g., a single serving cell) of the corresponding second set of serving cells. For example, the serving cell of the corresponding second set of serving cells may be configured by RRC signaling.

Additionally, the one or more DCI formats may also include at least one single-cell scheduling DCI format (e.g., DCI format 0_0, DCI format 0_1, DCI format 0_2, etc. as specified in 3GPP standard documents), wherein each single-cell scheduling DCI format of the at least one single-cell scheduling DCI format may schedule a PUSCH on a serving cell. In such case, the plurality of PUSCHs may include the PUSCH(s) scheduled by the at least one single-cell scheduling DCI format.

In some cases, the UE or the BS may determine that one or more PUSCHs of the plurality of PUSCHs overlap a PUCCH carrying HARQ-ACK feedback for a downlink transmission (e.g., one or more PDSCHs). In such cases, the UE may determine a reference PUSCH among the plurality of PUSCHs for multiplexing the HARQ-ACK feedback and not transmit the PUCCH.

In some embodiments, a DCI format of the one or more DCI formats which schedules the reference PUSCH may include a UL DAI. The DAI may indicate the number of {serving cell, PDCCH monitoring occasion}-pair(s) in which PDSCH transmission(s) associated with PDCCH or PDCCH indicating SPS PDSCH release or DCI format 1_1 indicating SCell dormancy is present.

In some embodiments, a DCI format of the one or more DCI formats may include a beta offset indicator. The beta offset indicator may be applicable for the reference PUSCH for adjusting resources of the HARQ-ACK feedback on the reference PUSCH.

In some embodiments, the reference PUSCH for multiplexing the HARQ-ACK feedback may satisfy a condition(s).

For example the reference PUSCH may be a PUSCH actually transmitted (e.g., condition (1)). Whether a PUSCH is actually transmitted may be determined as follows: for multiple cells scheduled by a DCI format, if, for a cell from the multiple cells, at least one symbol from a set of symbols where the UE is scheduled PUSCH transmission in the cell is a downlink symbol (e.g., as indicated by a cell common UL/DL configuration such as tdd-UL-DL-ConfigurationCommon as specified in 3GPP standard documents or a UE specific UL/DL configuration such as tdd-UL-DL-ConfigurationDedicated as specified in 3GPP standard documents), the UE does not transmit the PUSCH in the cell.

For example, considering the UE's processing delay on multiplexing HARQ-ACK feedback on a PUSCH, the reference PUSCH for multiplexing the HARQ-ACK feedback may satisfy the UE's processing delay requirement (e.g., condition (2)).

The plurality of PUSCHs based on which the reference PUSCH is determined may satisfy at least one of condition (1) or condition (2), and the plurality of serving cells are the serving cells scheduled by the one or more DCI formats on which the plurality of PUSCHs are transmitted.

FIG. 4 illustrates a schematic diagram of multiple DCI formats scheduling multiple PUSCHs in accordance with some embodiments of the present disclosure.

Referring to FIG. 4, the BS may transmit 3 DCI formats (e.g., denoted as DCI 1, DCI 2, and DCI 3) scheduling 6 PUSCHs on 6 serving cells to the UE. For example, DCI 1 is a single-cell scheduling DCI scheduling PUSCH 1 on CC1; DCI 2 is a multi-cell scheduling DCI scheduling PUSCH 2 on CC2 and PUSCH 3 on CC3; and DCI 3 is a multi-cell scheduling DCI scheduling PUSCH 4 on CC4, PUSCH 5 on CC5, and PUSCH 6 on CC6. It is assumed that the ascending order of the serving cell indices of CC1 to CC6 is CC1->CC2->CC3->CC4->CC5->CC6. In the example of FIG. 4, DCI 1, DCI 2, and DCI 3 are transmitted on CC1, CC1, and CC4, respectively. In some other examples, DCI 1, DCI 2, or DCI 3 can be transmitted on a different CC, for example, a CC different from CC1 to CC6.

In some examples, the 6 PUSCHs satisfy conditions (1) and (2).

As shown in FIG. 4, HARQ-ACK feedback for a PDSCH(s) is to be transmitted in a PUCCH which overlaps PUSCHs 1-6 in a time domain.

The following embodiments may provide several solutions for determining the reference PUSCH from the plurality of PUSCHs.

### Solution #1′

In solution #1′, when the plurality of serving cells include a PCell or PSCell, the BS and the UE determine the reference PUSCH to be a PUSCH on the PCell or the PSCell of the plurality of serving cells. In such embodiments, the HARQ-ACK feedback may be transmitted on a PCell or a PSCell with high reliability.

### Solution #2′

In solution #2′, the BS or the UE may determine the reference PUSCH to be a PUSCH which ends latest among the plurality of PUSCHs. In such embodiments, the UE may have sufficient time to multiplex HARQ-ACK feedback on the reference PUSCH. Referring to FIG. 4, in solution #2′, the BS or the UE may determine PUSCH 6 to be the reference PUSCH because PUSCH 6 ends latest among the 6 PUSCHs.

### Solution #3′

In solution #3′, the BS or the UE may determine the reference PUSCH to be a PUSCH which starts earliest among the plurality of PUSCHs. In such embodiments, the UE may transmit the HARQ-ACK feedback at the earliest time. Referring to FIG. 4, in solution #3′, the BS and the UE may determine PUSCH 4 to be the reference PUSCH because PUSCH 4 starts earliest among the 6 PUSCHs.

### Solution #4′

In solution #4′, the BS or the UE may determine the reference PUSCH to be a PUSCH which starts latest among the plurality of PUSCHs. In such embodiments, the UE may have sufficient time to multiplex HARQ-ACK feedback on the reference PUSCH. Referring to FIG. 4, in solution #4′, the BS and the UE may determine PUSCH 1 to be the reference PUSCH because PUSCH 1 starts latest among the 6 PUSCHs.

### Solution #5′

In solution #5′, the BS or the UE may determine the reference PUSCH to be a PUSCH with a pre-defined serving cell index among the plurality of serving cells. In some embodiments, solution #5 may be used in combination with other solutions for determining a reference PUSCH, for example, one of solutions #2′-4′. For instance, when there are two or more PUSCHs with the same starting time or ending time, solution #5′ may be further employed.

In some embodiments of solution #5′, the pre-defined serving cell index may be the smallest serving cell index among the plurality of serving cells. In such embodiments, referring to FIG. 4, the BS and the UE may determine PUSCH 1 to be the reference PUSCH because PUSCH 1 is transmitted on CC1 which has the smallest serving cell index.

In some embodiments of solution #5′, the pre-defined serving cell index may be the largest serving cell index among the plurality of serving cells. In such embodiments, referring to FIG. 4, the BS and the UE may determine PUSCH 6 to be the reference PUSCH because PUSCH 6 is transmitted on CC6 which has the largest serving cell index.

### Solution #6′

In solution #6′, the BS or the UE may determine the reference PUSCH to be a PUSCH with the most time-frequency resources among the plurality of PUSCHs. In such embodiments, the impact on the PUSCH due to multiplexing the HARQ-ACK feedback may be minimal. Referring to FIG. 4, in solution #6′, the BS and the UE may determine PUSCH 6 to be the reference PUSCH because PUSCH 6 has the most time-frequency resources among the 6 PUSCHs.

### Solution #7′

In solution #7′, the BS or the UE may determine the reference PUSCH to be a PUSCH with a pre-defined serving cell index among at least one PUSCH of the plurality of PUSCHs. The at least one PUSCH of the plurality of PUSCHs may have the same ending time.

In some embodiments of solution #7′, the pre-defined serving cell index may be the smallest serving cell index among at least one serving cells on which the at least one PUSCH is transmitted.

In some embodiments of solution #7′, the pre-defined serving cell index may be the largest serving cell index among at least one serving cells on which the at least one PUSCH is transmitted.

### Solution #8′

In solution #8′, the BS or the UE may determine the reference PUSCH to be a PUSCH with a pre-defined serving cell index among at least one PUSCH of the plurality of PUSCHs. The at least one PUSCH of the plurality of PUSCHs may have the same starting time.

In some embodiments of solution #8′, the pre-defined serving cell index may be the smallest serving cell index among at least one serving cells on which the at least one PUSCH is transmitted.

In some embodiments of solution #8′, the pre-defined serving cell index may be the largest serving cell index among at least one serving cells on which the at least one PUSCH is transmitted.

In solution #9′, only one PUSCH of the plurality of PUSCHs may overlap the PUCCH. Then, the BS and the UE may determine the reference PUSCH to be the one PUSCH.

### Solution #10′

In solution #10′, the BS or the UE may determine the reference PUSCH to be a PUSCH which ends latest among the one or more PUSCHs of the plurality of PUSCHs. As stated above, the one or more PUSCHs overlap the PUCCH. In such embodiments, the UE may have sufficient time to multiplex HARQ-ACK feedback on the reference PUSCH.

In solution #10′, referring to FIG. 4, the BS and the UE may determine PUSCH 6 to be the reference PUSCH because PUSCH 6 ends latest among the 6 PUSCHs.

### Solution #11′

In solution #11′, the BS or the UE may determine the reference PUSCH to be a PUSCH which starts earliest among the one or more PUSCHs of the plurality of PUSCHs. As stated above, the one or more PUSCHs overlap the PUCCH. In such embodiments, the UE may transmit the HARQ-ACK feedback at the earliest time. Referring to FIG. 4, in solution #11′, the BS and the UE may determine PUSCH 4 to be the reference PUSCH because PUSCH 4 starts earliest among the 6 PUSCHs.

### Solution #12′

In solution #12′, the BS or the UE may determine the reference PUSCH to be a PUSCH which starts latest among the one or more PUSCHs of the plurality of PUSCHs. As stated above, the one or more PUSCHs overlap the PUCCH. In such embodiments, the UE may have sufficient time to multiplex HARQ-ACK feedback on the reference PUSCH. Referring to FIG. 4, in solution #12′, the BS and the UE may determine PUSCH 1 to be the reference PUSCH because PUSCH 1 starts latest among the 6 PUSCHs.

### Solution #13′

In solution #13′, the BS or the UE may determine the reference PUSCH to be a PUSCH on a serving cell with a pre-defined serving cell index among the serving cells carrying the one or more PUSCHs overlapping the PUCCH. In some embodiments, solution #13′ may be used in combination with other solutions for determining a reference PUSCH, for example, one of solutions #10′-12′. For instance, when there are two or more PUSCHs with the same starting time or ending time, solution #13′ may be further employed.

In some embodiments of solution #13′, the pre-defined serving cell index may be the smallest serving cell index. In such embodiments, referring to FIG. 4, the BS and the UE may determine PUSCH 1 to be the reference PUSCH because PUSCH 1 is transmitted on CC1 which has the smallest serving cell index.

In some embodiments of solution #13′, the pre-defined serving cell index may be the largest serving cell index. In such embodiments, referring to FIG. 4, the BS and the UE may determine PUSCH 6 to be the reference PUSCH because PUSCH 6 is transmitted on CC6 which has the largest serving cell index.

### Solution #14′

In solution #14′, the BS or the UE may determine the reference PUSCH to be a PUSCH with the most time-frequency resources among the one or more PUSCHs of the plurality of PUSCHs. As stated above, the one or more PUSCHs overlap with the PUCCH. In such embodiments, the impact on the PUSCH due to multiplexing the HARQ-ACK feedback may be minimal. Referring to FIG. 4, in solution #14′, the BS and the UE may determine PUSCH 6 to be the reference PUSCH because PUSCH 6 has the most time-frequency resources among the 6 PUSCHs.

### Solution #15′

In solution #15′, the BS or the UE may determine the reference PUSCH to be a PUSCH on a serving cell with a pre-defined serving cell index among the serving cell(s) carrying at least one PUSCH of the one or more PUSCHs overlapping the PUCCH. The at least one PUSCH of the plurality of PUSCHs may have the same ending time.

In some embodiments of solution #15′, the pre-defined serving cell index may be the smallest serving cell index among the serving cell(s) on which the at least one PUSCH is transmitted. In such embodiments, referring to FIG. 4, since PUSCH 1 and PUSCH 2 may have the same ending time, the BS and the UE may determine PUSCH 1 to be the reference PUSCH because PUSCH 1 is transmitted on CC1 which has the smallest serving cell index among CC1 and CC2.

In some embodiments of solution #15′, the pre-defined serving cell index may be the largest serving cell index among the serving cell(s) on which the at least one PUSCH is transmitted. In such embodiments, referring to FIG. 4, since PUSCH 1 and PUSCH 2 may have the same ending time, the BS and the UE may determine PUSCH 2 to be the reference PUSCH because PUSCH 2 is transmitted on CC2 which has the largest serving cell index among CC1 and CC2.

### Solution #16′

In solution #16′, the BS or the UE may determine the reference PUSCH to be a PUSCH on a serving cell with a pre-defined serving cell index among the serving cell(s) carrying at least one PUSCH of the one or more PUSCHs overlapping the PUCCH. The at least one PUSCH of the plurality of PUSCHs may have the same starting time.

In some embodiments of solution #16′, the pre-defined serving cell index may be the smallest serving cell index among the serving cell(s) on which the at least one PUSCH is transmitted.

In some embodiments of solution #16′, the pre-defined serving cell index may be the largest serving cell index among the serving cell (s_ on which the at least one PUSCH is transmitted.

The BS and the UE may use at least one solution of the above solutions to determine the reference PUSCH from the plurality of PUSCHs. Then, the UE may transmit the plurality of PUSCHs, wherein the HARQ-ACK feedback is multiplexed on the reference PUSCH. Consequently, the BS may receive the plurality of PUSCHs, wherein the HARQ-ACK feedback is multiplexed on the reference PUSCH.

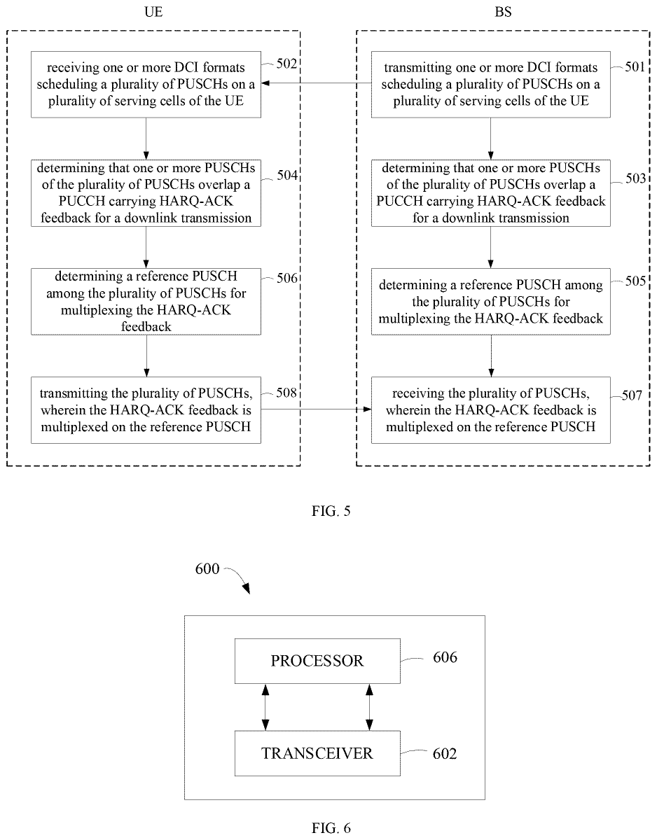

FIG. 5 is a flow chart illustrating an exemplary method for HARQ-ACK feedback multiplexing on a PUSCH according to some embodiments of the present disclosure. The method illustrated in FIG. 5 may be performed by a UE (e.g., UE 101 as shown in FIG. 1) and a BS (e.g., BS 102 as shown in FIG. 1). Although the method is illustrated in a system level, persons skilled in the art can understand that the method implemented in the UE and the BS can be separately implemented and incorporated in other apparatus with the like functions.

In the exemplary method shown in FIG. 5, in step 501, the BS may transmit, to the UE, one or more DCI formats scheduling a plurality of PUSCHs on a plurality of serving cells of the UE. Consequently, in step 502, the UE may receive, from the BS, the one or more DCI formats scheduling the plurality of PUSCHs on the plurality of serving cells of the UE. The one or more DCI formats may include a multi-cell scheduling DCI format in Embodiment 1 or include a DCI format(s) in Embodiment 2.

For example, the one or more DCI formats may include at least one multi-cell scheduling DCI format, each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.

In an embodiment, the corresponding second set of serving cells is configured with a parameter (e.g., n_{CI} as stated above) for determining CCEs of PDCCH candidates for monitoring the multi-cell scheduling DCI format.

In an embodiment, a DCI size of each of the at least one multi-cell scheduling DCI format is counted on a serving cell of the corresponding second set of serving cells. For example, the serving cell of the corresponding second set of serving cells may be configured by RRC signaling.

In an embodiment, a BD or CCE budget of each of the at least one multi-cell scheduling DCI format is counted on a serving cell of the corresponding second set of serving cells. For example, the serving cell of the corresponding second set of serving cells may be configured by RRC signaling

In an embodiment, a search space of each of the at least one multi-cell scheduling DCI format is configured on a serving cell of the corresponding second set of serving cells. For example, the serving cell of the corresponding second set of serving cells may be configured by RRC signaling.

In steps 503 and 504, the BS and the UE may determine that one or more PUSCHs of the plurality of PUSCHs overlap a PUCCH carrying HARQ-ACK feedback for downlink transmission (e.g., one or more PDSCHs), respectively.

In steps 505 and 506, the BS and the UE may determine a reference PUSCH among the plurality of PUSCHs for multiplexing the HARQ-ACK feedback, respectively. The BS and the UE may use the same solution(s) to determine the reference PUSCH among the plurality of PUSCHs.

In some embodiments, the reference PUSCH may satisfy the UE's processing delay requirement on multiplexing the HARQ-ACK feedback.

In some embodiments, a DCI format (e.g., a DCI format scheduling the reference PUSCH) of the one or more DCI formats may include a beta offset indicator applicable for the reference PUSCH for adjusting resources of the HARQ-ACK feedback on the reference PUSCH.

In some embodiments, the UE or the BS may perform at least one of the following operations to determine the reference PUSCH:
determining the reference PUSCH to be a PUSCH on a PCell or a PSCell of the plurality of serving cells;
determining the reference PUSCH to be a PUSCH which ends latest among the plurality of PUSCHs;
determining the reference PUSCH to be a PUSCH which starts earliest among the plurality of PUSCHs;
determining the reference PUSCH to be a PUSCH which starts latest among the plurality of PUSCHs;
determining the reference PUSCH to be a PUSCH with the smallest serving cell index among the plurality of serving cells;
determining the reference PUSCH to be a PUSCH with the largest serving cell index among the plurality of serving cells;
determining the reference PUSCH to be a PUSCH on a serving cell with a predefined order among a combination of serving cells indicated by a DCI format among the one or more DCI formats;
determining the reference PUSCH to be a PUSCH with the most time-frequency resources among the plurality of PUSCHs;
determining the reference PUSCH to be a PUSCH with the smallest serving cell index among at least one PUSCH of the plurality of PUSCHs with the same ending time;
determining the reference PUSCH to be a PUSCH with the largest serving cell index among at least one PUSCH of the plurality of PUSCHs with the same ending time;
determining the reference PUSCH to be a PUSCH with the smallest serving cell index among at least one PUSCH of the plurality of PUSCHs with the same starting time; or
determining the reference PUSCH to be a PUSCH with the largest serving cell index among at least one PUSCH of the plurality of PUSCHs with the same starting time.

In some embodiments, the UE or the BS may perform at least one of the following operations to determine the reference PUSCH:
in the case that only one PUSCH of the plurality of PUSCHs overlaps the PUCCH, determining the reference PUSCH to be the one PUSCH;
determining the reference PUSCH to be a PUSCH which ends latest among the one or more PUSCHs;
determining the reference PUSCH to be a PUSCH which starts earliest among the one or more PUSCHs;
determining the reference PUSCH to be a PUSCH which starts latest among the one or more PUSCHs;
determining the reference PUSCH to be a PUSCH with the smallest serving cell index among the one or more PUSCHs;
determining the reference PUSCH to be a PUSCH with the largest serving cell index among the one or more PUSCHs;
determining the reference PUSCH to be a PUSCH with the most time-frequency resources among the one or more PUSCHs;
determining the reference PUSCH to be a PUSCH with a predefined smallest serving cell index among at least one PUSCH of the one or more PUSCHs with the same ending time;
determining the reference PUSCH to be a PUSCH with the largest serving cell index among at least one PUSCH of the one or more PUSCHs with the same ending time;
determining the reference PUSCH to be a PUSCH with the smallest serving cell index among at least one PUSCH of the one or more PUSCHs with the same starting time; or
determining the reference PUSCH to be a PUSCH with a predefined largest serving cell index among at least one PUSCH of the one or more PUSCHs with the same starting time.

In step 508, the UE may transmit the plurality of PUSCHs to the BS, wherein the HARQ-ACK feedback is multiplexed on the reference PUSCH. Consequently, in step 507, the BS may receive the plurality of PUSCHs from the UE, wherein the HARQ-ACK feedback is multiplexed on the reference PUSCH.

FIG. 6 illustrates a simplified block diagram of an exemplary apparatus for HARQ-ACK feedback multiplexing on a PUSCH according to some embodiments of the present disclosure. As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 606 may interact with each other so as to perform the operations with respect to the UE described in FIGS. 1-5. In some embodiments of the present disclosure, the apparatus 600 may be a BS. The transceiver 602 and the processor 606 may interact with each other so as to perform the operations with respect to the BS described in FIGS. 1-5.

In some embodiments of the present disclosure, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602 to perform the operations with respect to the UE described in FIGS. 1-5.

In some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
receive one or more downlink control information (DCI) formats scheduling a plurality of physical uplink shared channels (PUSCHs) on a plurality of serving cells of the UE;
determine that one or more PUSCHs of the plurality of PUSCHs overlap a physical uplink control channel (PUCCH) carrying hybrid automatic repeat request acknowledgement (HARQ-ACK) feedback for downlink transmission;
determine a reference PUSCH among the plurality of PUSCHs for multiplexing the HARQ-ACK feedback; and
transmit the plurality of PUSCHs, wherein the HARQ-ACK feedback is multiplexed on the reference PUSCH.

2. The UE of claim 1, wherein the reference PUSCH satisfies a processing delay requirement for the UE and associated with multiplexing the HARQ-ACK feedback.

3. The UE of claim 1, wherein a DCI format of the one or more DCI formats includes a beta offset indicator applicable for the reference PUSCH for adjusting resources of the HARQ-ACK feedback on the reference PUSCH.

4. The UE of claim 1, wherein the one or more DCI formats comprise at least one multi-cell scheduling DCI format, and wherein each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.

5. The UE of claim 4, wherein the corresponding second set of serving cells is configured with a parameter for determining control channel elements (CCEs) of physical downlink control channel (PDCCH) candidates for monitoring the multi-cell scheduling DCI format.

6. The UE of claim 4, wherein a DCI size of each of the at least one multi-cell scheduling DCI format is counted on a serving cell of the corresponding second set of serving cells.

7. The UE of claim 4, wherein a blind detection (BD) or control channel element (CCE) budget of each of the at least one multi-cell scheduling DCI format is counted on a serving cell of the corresponding second set of serving cells.

8. The UE of claim 4, wherein a search space of each of the at least one multi-cell scheduling DCI format is configured on a serving cell of the corresponding second set of serving cells.

9. The UE of claim 6, wherein the serving cell of the corresponding second set of serving cells is configured by radio resource control (RRC) signaling.

10. The UE of claim 1, wherein, to determine the reference PUSCH, the at least one processor is further configured to cause the UE to:
determining the reference PUSCH as a PUSCH on a primary cell (PCell) or a primary secondary cell (PSCell) of the plurality of serving cells;
determining the reference PUSCH as a PUSCH that ends latest among the plurality of PUSCHs;
determining the reference PUSCH as a PUSCH that starts earliest among the plurality of PUSCHs;
determining the reference PUSCH as a PUSCH that starts latest among the plurality of PUSCHs;
determining the reference PUSCH as a PUSCH with a smallest serving cell index among the plurality of serving cells;
determining the reference PUSCH as a PUSCH with a largest serving cell index among the plurality of serving cells;
determining the reference PUSCH as a PUSCH on a serving cell with a predefined order among a combination of serving cells indicated by a DCI format among the one or more DCI formats;
determining the reference PUSCH as a PUSCH with the most time-frequency resources among the plurality of PUSCHs;
determining the reference PUSCH as a PUSCH with a smallest serving cell index among at least one PUSCH of the plurality of PUSCHs with the same ending time;
determining the reference PUSCH as a PUSCH with a largest serving cell index among at least one PUSCH of the plurality of PUSCHs with the same ending time;
determining the reference PUSCH as a PUSCH with a smallest serving cell index among at least one PUSCH of the plurality of PUSCHs with the same starting time; or
determining the reference PUSCH as a PUSCH with a largest serving cell index among at least one PUSCH of the plurality of PUSCHs with the same starting time.

11. The UE of claim 1, wherein, to determine the reference PUSCH, the at least one processor is further configured to cause the UE to:
when only one PUSCH of the plurality of PUSCHs overlaps the PUCCH, determining the reference PUSCH as the only one PUSCH;
determining the reference PUSCH as a PUSCH that ends latest among the one or more PUSCHs;
determining the reference PUSCH as a PUSCH that starts earliest among the one or more PUSCHs;
determining the reference PUSCH as a PUSCH that starts latest among the one or more PUSCHs;
determining the reference PUSCH as a PUSCH with a smallest serving cell index among the one or more PUSCHs;
determining the reference PUSCH as a PUSCH with a largest serving cell index among the one or more PUSCHs;
determining the reference PUSCH as a PUSCH with the most time-frequency resources among the one or more PUSCHs;
determining the reference PUSCH as a PUSCH with a smallest serving cell index among at least one PUSCH of the one or more PUSCHs with the same ending time;
determining the reference PUSCH as a PUSCH with a largest serving cell index among at least one PUSCH of the one or more PUSCHs with the same ending time;
determining the reference PUSCH as a PUSCH with a smallest serving cell index among at least one PUSCH of the one or more PUSCHs with the same starting time; or
determining the reference PUSCH as a PUSCH with a largest serving cell index among at least one PUSCH of the one or more PUSCHs with the same starting time.

12. A base station (BS) for wireless communication, comprising:
at least one memory; and
at least one processor coupled with the at least one memory and configured to cause the BS to;
transmit, to a user equipment (UE), one or more downlink control information (DCI) formats scheduling a plurality of physical uplink shared channels (PUSCHs) on a plurality of serving cells of the UE;
determine that one or more PUSCHs of the plurality of PUSCHs overlap a physical uplink control channel (PUCCH) carrying hybrid automatic repeat request acknowledgement (HARQ-ACK) feedback for downlink transmission;
determine a reference PUSCH among the plurality of PUSCHs for multiplexing the HARQ-ACK feedback; and
receive the plurality of PUSCHs, wherein the HARQ-ACK feedback is multiplexed on the reference PUSCH.

13. The BS of claim 12, wherein the one or more DCI formats comprise at least one multi-cell scheduling DCI format, wherein each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.

14. The BS of claim 13, wherein the corresponding second set of serving cells is configured with a parameter for determining control channel elements (CCEs) of physical downlink control channel (PDCCH) candidates for monitoring the multi-cell scheduling DCI format.

15. A method performed by a user equipment (UE), the method comprising:
receiving one or more downlink control information (DCI) formats scheduling a plurality of physical uplink shared channels (PUSCHs) on a plurality of serving cells of the UE;
determining that one or more PUSCHs of the plurality of PUSCHs overlap a physical uplink control channel (PUCCH) carrying hybrid automatic repeat request acknowledgement (HARQ-ACK) feedback for downlink transmission;
determining a reference PUSCH among the plurality of PUSCHs for multiplexing the HARQ-ACK feedback; and
transmitting the plurality of PUSCHs, wherein the HARQ-ACK feedback is multiplexed on the reference PUSCH.

16. The method of claim 15, wherein the reference PUSCH satisfies a processing delay requirement for the UE and associated with multiplexing the HARQ-ACK feedback.

17. The method of claim 15, wherein a DCI format of the one or more DCI formats includes a beta offset indicator applicable for the reference PUSCH for adjusting resources of the HARQ-ACK feedback on the reference PUSCH.

18. The method of claim 15, wherein the one or more DCI formats comprise at least one multi-cell scheduling DCI format, and wherein each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.

19. A method performed by a base station (BS), the method comprising:
transmitting, to a user equipment (UE), one or more downlink control information (DCI) formats scheduling a plurality of physical uplink shared channels (PUSCHs) on a plurality of serving cells of the UE;
determining that one or more PUSCHs of the plurality of PUSCHs overlap a physical uplink control channel (PUCCH) carrying hybrid automatic repeat request acknowledgement (HARQ-ACK) feedback for downlink transmission;
determining a reference PUSCH among the plurality of PUSCHs for multiplexing the HARQ-ACK feedback; and
receiving the plurality of PUSCHs, wherein the HARQ-ACK feedback is multiplexed on the reference PUSCH.

20. The method of claim 19, wherein the one or more DCI formats comprise at least one multi-cell scheduling DCI format, wherein each of the at least one multi-cell scheduling DCI format schedules a respective first set of serving cells among the plurality of serving cells, and the respective first set of serving cells is a subset of a corresponding second set of serving cells configured for multi-cell scheduling using a multi-cell scheduling DCI format.
